(19) United States
(12) Patent Application Publication
(10) Pub. No.: US 2012/0250723 A1
(43) Pub. Date: Oct. 4, 2012

(54) System And Method For Thermal Analysis

(76) Inventor: Juergen Blumm, Selb (DE)

(21) Appl. No.: 13/475,208

(22) Filed: May 18, 2012

Related U.S. Application Data
(63) Continuation of application No. PCT/DE2010/001350, filed on Nov. 17, 2010.

(30) Foreign Application Priority Data
Nov. 20, 2009 (DE) 10 2009 054 086.5

(51) Int. Cl. G01N 25/00

(52) U.S. Cl. 374/13

(57) ABSTRACT

A system for thermal analysis, including a sample crucible on a sample side and a reference crucible on a reference side in a measurement chamber, where the sample cup and the reference cup are each provided with a Peltier system for adjusting the temperature and/or for detecting the temperature.

### CROSS-REFERENCE TO RELATED APPLICATIONS

The present application is a continuation of pending International Patent Application PCT/DE2010/001350 filed on Nov. 17, 2010 which designates the United States and claims priority from German Patent Application 10 2009 054 086.5 filed on Nov. 20, 2009, the content of which is incorporated herein by reference.

### FIELD OF THE INVENTION

The present invention relates to a system for thermal analysis, wherein a sample crucible is arranged on a sample side and a reference crucible is arranged on a reference side, and wherein both crucibles are arranged in a measuring chamber.

### BACKGROUND OF THE INVENTION

One method for analysing materials with the application of heat is differential thermal analysis (DTA), from the group of thermal analysis methods. DTA is based on a characteristic energy consumption during phase transition and it enables qualitative analysis. Temperatures of the sample and a selected reference substance are each measured in a crucible in a symmetrical measuring chamber and compared. The reference substance is selected such that it does not have any phase transitions in the temperature range that is to be examined. A constant supply of energy is provided via a furnace. The temperatures under both crucibles are measured via temperature sensors and the difference between them is recorded. At phase transition points only, the temperature differential is of a significant order, and the curve plotted can then be used to draw conclusions about the composition of the sample.

The technique of differential scanning calorimetry (DSC) was developed from DTA. Instead of recording the temperature difference between the two crucibles as a function of the energy applied or the temperature of the reference substance directly, as in DTA, in DSC the difference in thermal flux is calculated. From this, characteristic temperatures and calorific parameters can be determined.

DTA is used frequently in such applications as the examination of minerals, for example clinker phase formation in cement raw meals, determining the heat of reaction during combustion of organic substances, and characterizing plastics. Dynamic differential scanning calorimeters (DDSCM) are recognised all over the world as instruments for material characterisation. The systems are used in the analysis of polymers, pharmaceutical active agents, textiles, metals, ceramics and other organic and inorganic materials. Typically, two ceramic or metal crucibles are used to hold the sample and reference in these measuring devices.

When conducting a measurement, both crucibles are placed in a furnace, either in the same one or each in a separate furnace, in which case the two furnaces may be operated in parallel. The two crucibles undergo the same temperature programme. In one variation, the difference in the electrical power required to keep a temperature difference between the two crucibles constant, typically at 0, is measured. This is called power compensated DSC. Alternatively, the temperature difference or a comparable variable of the two crucibles may also be measured directly. When the DTA principle is used, the temperature difference may be recorded directly. The temperature difference may equally be converted to a difference in the thermal flux. These are called thermal flux DSCs, though these need a suitable heat flux sensor in order to function. The measurement variables may then serve as the basis for determining various material properties, such as phase transition temperatures, specific heats, melting and solidification temperatures, and so on. Dynamic differential scanning calorimetry is recognised and has been standardised all over the world (ISO 11357, DIN 53765, ASTM E 967, ASTM 968 or ASTM D 3418).

Nowadays, various devices and methods are used to determine the thermal flux difference between the sample and the reference. Until now, in keeping with practical experience resistance heaters, resistance thermometers, thermocouples or thermopiles have been used as temperature sensors or heating/cooling devices. In a power-compensated DSC, two small furnaces equipped with a resistance heating system are used. Commercial systems frequently work with a platinum heating coil. On the other hand, thermal flux DCSs use only one furnace, in which a sensor with two surfaces or defined positions for the sample and the reference side is installed. During the measurement, the corresponding crucibles are placed on the sample and the reference side. The sensors serve to measure either the temperature difference or else the thermal flux difference directly. This is achieved in practice by placing a temperature measuring device in contact with the sample side and the reference side. In DTAs, thermocouples are used for this, being placed in or on the sample crucible and the reference crucible. With thermal flux DSCs, the temperature is measured with temperature measuring devices that are placed in or on the respective sensor surfaces. The temperature measuring devices used in practice most frequently these days are PT100 resistance thermometers, welded thermocouples or thermopiles.

U.S. Pat. No. 5,288,147 discloses a device for thermal analysis in which the sample and reference crucibles are each provided with a thermoelectric generator for capturing the temperature. These generators are connected to a computer. A thermocouple and a heating unit as well as various compensators are also connected to this computer. The heating power of the heating unit is controlled via the information that is collected in the computer.

In German patent application DE 103 55 126 A1, a method for measuring the heat that is released during chemical or physical reactions is suggested. The components that are to be brought together for reacting are introduced into a reactor and the heat that is released there is measured. During the process, the components are fed into the reactor continuously, and the released heat is measured with the reactor under essentially isothermal temperature control by bringing the reactor into thermally conductive contact with a Seebeck element and controlling the reactor temperature with a Peltier element until the electrical voltage induced in the Seebeck element is essentially equal to zero. The heat released during the reaction is then measured depending on the voltage that must be applied to the Peltier in order to maintain an induced voltage of essentially zero in the Seebeck element, or depending on the voltage induced in a second Seebeck element arranged between the reactor and the Peltier element. The invention further relates to a device for carrying out such a method.

### SUMMARY OF THE INVENTION

Thus, the object of the invention is to create a system and method with which the resolution during thermal analysis is improved.

This object is solved according to the invention with a system for thermal analysis as described in claim 1 and a method for thermal analysis as described in claim 13. Further preferred and/or advantageous variations of the invention will be evident from the subordinate claims and combinations thereof, and from a consideration of all of the submitted application documents.

A thermal analysis system is disclosed that is furnished with a sample crucible on a sample side and with a reference crucible on a reference side. In the system according to the invention, both crucibles are positioned in a measuring chamber. The sample crucible and the reference crucible are each provided with a Peltier system for recording and/or adjusting the temperature. A thermoelectric generator may be used instead of the Peltier system for capturing the temperature. It is also conceivable that resistance thermometers and/or thermocouples such as are known from the related art and depending on the field of application might be used to capture the temperature.

The thermal analysis system is designed to take measurements by dynamic differential scanning calorimetry or differential thermal analysis. In a preferred embodiment, the system is configured to perform thermal analysis purely as a dynamic differential scanning calorimeter.

The sample and reference sides of the thermal analysis system are constructed symmetrically. Each Peltier system and/or thermoelectric generator is made from at least one material that is designed for use at temperatures above 200° C., preferably above 700° C. Each Peltier system and/or thermoelectric generator is also of modular construction, built from a number of identical components. This modular construction is used particularly when the system is operated as a dynamic differential scanning calorimeter.

Each Peltier system is wired electrically in such manner that the thermal analysis system is available for operation as a dynamic heat flux differential calorimeter and/or as a power-compensated dynamic differential scanning calorimeter. The thermal analysis system is also configured as a hybrid dynamic differential scanning calorimeter on a Peltier base. The analysis system may be operated optionally as a power-compensated dynamic differential scanning calorimeter or a heat flux differential calorimeter.

The Peltier system and/or the thermoelectric generator located inside the dynamic differential scanning calorimeter is/are made from a SiGe semiconductor material. Each Peltier system and/or thermoelectric generator in the dynamic differential scanning calorimeter contains tellurium, lead, bismuth, or alloys and/or compounds of these elements. In a preferred embodiment, the components of the dynamic differential scanning calorimeter described in the preceding are constructed from skutterudite systems.

The surface of each Peltier system and/or thermoelectric generator is scratch-proof and/or corrosion-resistant. For this purpose, ceramic materials may be used for example. The use of scratch-proof and/or corrosion-resistant materials is always dependent on the operating conditions of the system. Different materials must be chosen for the surfaces depending on the temperatures required and/or the materials (samples) that are to be analysed. A person skilled in the art will know that there are many materials suitable for use in thermal analysis. The previous example thus does not represent a definitive limitation of the invention.

A method for thermal analysis is also disclosed wherein a system is used that is equipped with a sample crucible on a sample side and a reference crucible on a reference side. The sample side and the reference side are located in one measuring chamber. A system based on the Peltier effect is used to record and/or adjust the temperature on the sample crucible and the reference crucible. It is also possible to use a thermoelectric generator to capture the temperature at the sample crucible and the reference crucible.

The resolution offered by today's dynamic differential scanning calorimeters is often limited. The resolution of the electrical outputs, resistances or voltages captured is only limited. The sensitivity of the system in conventional thermocouples can be determined using the Seebeck coefficient. Conventional platinum-based thermocouples are usable in a wide temperature range, but they only have a low Seebeck coefficient (<10 μV/K) and thus also low output sensitivity. Other conventional thermocouples may offer higher Seebeck coefficients, but their application range is limited to some degree. To date, no conventional thermocouples have been found in practice to have a Seebeck coefficient higher than 100 μV/K.

The present invention now shows that higher Seebeck coefficients may be achieved with special semiconductor materials. For example, Seebeck coefficients higher than 400 μV/K may be achieved with doped bismuth telluride (Bi₂Te₃). Such system elements or systems constructed from corresponding modules are usually called Peltier systems or thermoelectric generators. If multiple elements or modules are connected in series, Seebeck coefficients of several thousand μV/K are possible, and it is possible to create such systems in a very small space. Today there are also semiconductor materials that are suitable for use mainly in the temperature range of dynamic differential scanning calorimeters up to 700° C. and higher. In this context, it is particularly advantageous that such systems may be used optionally both as temperature sensors and as heating and cooling devices without any technical modification to the elements or modules; only the arrangement for electrical control is different. Thus, two elements or modules may be brought to the same surface temperature by the controlled supply of electrical power. But by measuring the voltage the same thermal analysis system may also be used directly to measure temperature differences. In principle, the same arrangement may be used for this purpose without having to replace a sensor (Peltier system or thermoelectric generator).

One advantage of the invention is the inclusion of Peltier systems for use in an classic dynamic differential scanning calorimeter (heat flux or power-compensated system). In this context, the Peltier systems may be used either as heating or cooling devices. It thus becomes possible to operate them as power-compensated dynamic differential scanning calorimeters simply and precisely. The Peltier system may be used as a temperature sensor just as simply and precisely to create a classic dynamic heat flux differential scanning calorimeter. Individual Peltier elements and modules comprising several Peltier elements may be used as temperature measuring devices or as heating/cooling devices.

Depending on the desired or required sensitivity within the operating temperature range in question, doped semiconductor materials may be used that function in a temperature range up to 700° C. and above. This temperature range corresponds to the operating temperature range most frequently employed for dynamic differential scanning calorimeters. Modules of multiple Peltier elements may be stacked or connected in series to achieve even greater sensitivity. In addition, Peltier elements and modules may be furnished with scratch-proof and corrosion-resistant surfaces, such as ceramic plates, to ensure non-destructive handling and to enable contamination to be removed easily.

In the following, exemplary embodiments of the invention and its advantages will be explained in greater detail with reference to the accompanying figures.

### BRIEF DESCRIPTION OF THE DRAWINGS

FIG. 1 is a diagrammatic representation of a first embodiment of a thermal analysis system.

FIG. 2 is is a diagrammatic representation of a detail of a second embodiment of a thermal analysis system.

### DETAILED DESCRIPTION OF THE INVENTION

In the following, the embodiments and applications of the invention as provided in the description and representations in the drawings serve to explain the invention in greater detail purely in exemplary terms, that is to say it is not limited to these embodiments and applications or to the respective combinations of features in individual examples of embodiments and applications. Method and device features may be derived similarly from the respective descriptions of the device and method.

Individual features that are described and/or illustrated in the context of specific embodiments are not limited to these embodiments or the combination of such with other features of these embodiments, they may rather be combined with features and variants of other embodiments and with any other variants within the limits of the technically possible, even if such are not dealt with explicitly in the present documents.

The same or similar components, or components having similar function are designated with the same reference numbers in the various figures of the drawing.

Device and method features are also evident from the respective pictorial and textual representations of methods and devices.

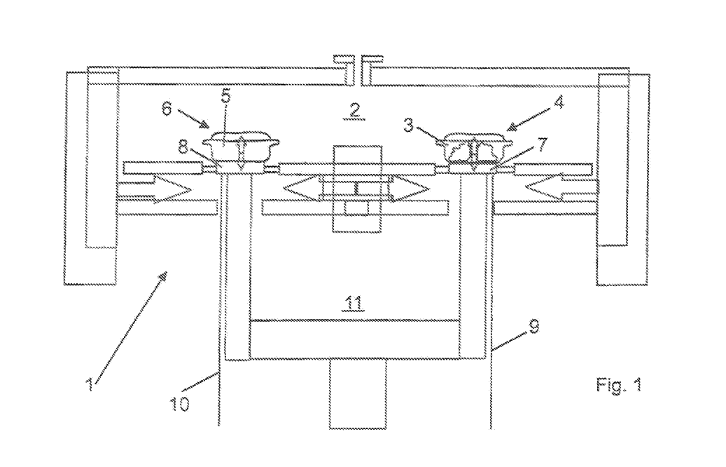

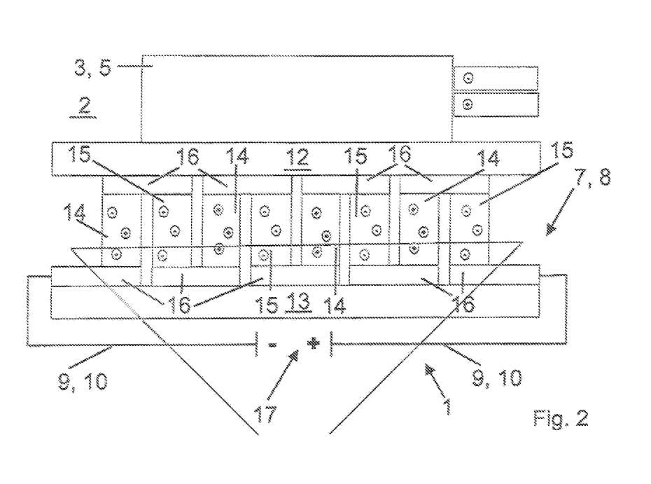

FIGS. 1 and 2 are respectively diagrammatical representations of a cross-section through a first embodiment and a detail of a second embodiment of a thermal analysis system 1. These thermal analysis systems 1 each have the form of dynamic differential scanning calorimeters.

A cross-section through a first embodiment of a thermal analysis system 1 with implementation of Peltier-based differential scanning calorimetry sensing equipment is illustrated diagrammatically in FIG. 1. In a measuring chamber 2, a sample crucible 3 is arranged on a sample side 4 and a reference crucible 5 is arranged on a reference side 6. A thermoelectric generator to capture the temperature and/or a Peltier system to adjust the temperature 7, 8 is fitted in the bottoms of both sample crucible 3 and reference crucible 5. The thermoelectric generator to capture the temperature and/or the Peltier system to adjust the temperature 7, 8 each serve as sensor devices for dynamic differential scanning calorimetry. Electrical supply means 9, 10 for Peltier systems 7, 8 are also represented symbolically. Measuring chamber 2 is heated using controllable heating devices that are generally known for the technical area in question, so that a desired or required temperature progression is guaranteed within measuring chamber 2. The combinations of sample crucible 3 with associated Peltier system 7 and reference crucible 5 with associated Peltier system 8 are located on a cooling block 11.

FIG. 2 is a diagrammatic representation of a cross-section through a detail of a second embodiment of a thermal analysis system 1. Compared with the illustration of FIG. 1, this shows an enlarged representation of the combination of one of the crucibles (sample crucible 3 and reference crucible 5 are identical) with a Peltier system 7 or 8. As is also shown clearly in the illustration of the first embodiment according to FIG. 1, thermal analysis system 1 is constructed symmetrically in terms of the sample and reference sides 4 and 6.

Peltier system 7 or 8 (both Peltier systems 7 and 8 are identical) contains a plurality of p-doped and n-doped SiGe semiconductor cubes or blocks 14 or 15 alternatingly between two aluminium oxide layers 12 and 13. Other alternative materials are: tellurium, lead, bismuth, alloys thereof and/or composite therewith. A construction made from or with skutterudite systems is also possible. The p- and n-doped SiGe semiconductor cubes 14 or 15 are connected to each other alternatingly at the top and bottom by metal bridges, in the present embodiment by gold contacts 16. Preferably, metal bridges or gold contacts 16 form the thermal contact surfaces and at the same time are insulated by a foil or ceramic plate (not shown) placed over them. Two different cubes are always connected to one another so as to form a series connection. An applied electrical current flows through all cubes 14 and 15 one after the other. The upper connection points for example cool down in accordance with the strength and direction of the current, while the lower connection points heat up. The current thus pumps heat from one side to the other and creates a temperature differential between the plates.

One very common form of Peltier elements or systems 7, 8 is made up of two mostly cuboid plates 12, 13 of aluminium oxide-ceramic having an edge length of 20 mm to 90 mm and a separation of 3 mm to 5 mm, with the semiconductor cubes 14 and 15 soldered between them. The ceramic surfaces are provided with metal surfaces (not shown) that are capable of being soldered on their facing sides for this purpose.

The electrical supply wires or supply means 9 (or 10) and the exemplary polarity of the corresponding electrical connection 17 are also shown again.

As a variation, it may also be provided to integrate a standard temperature sensor (not shown) on each side (sample side 4 and reference side 6), although this then only serves to measure the temperature, not the temperature differential, and requires two more wires on each sensor surface. The Peltier elements or systems are also used to precisely measure or determine the temperature differences between the sample and the reference (or more precisely sample crucible 3 and reference crucible 5) as accurately as possible.

In the case of a hybrid sensor, the Peltier systems are not used to measure temperatures, the supply wires provided according to the operating mode described in the preceding are used to provide electrical coupling in such manner that there is no temperature difference between the sample and the reference (or more precisely sample crucible 3 and reference crucible 5), and the power-compensated dynamic differential calorimetry is performed with the necessary electrical power.

1. A thermal analysis system comprising a sample crucible on a sample side and a reference crucible on a reference side in a measuring chamber, characterized in that the sample crucible and the reference crucible are each provided with a Peltier system for capturing and/or adjusting the temperature.

2. The thermal analysis system as recited in claim 1, characterized in that a thermoelectric generator is usable to capture the temperature instead of the Peltier system.

3. The thermal analysis system as recited in claim 1, characterized in that thermal analysis system is designed to perform dynamic differential scanning calorimetry or differential thermoanalysis, or that the thermal analysis system is preferably a dynamic differential scanning calorimeter.

4. The thermal analysis system as recited in claim 1, characterized in that the sample and reference sides of the thermal analysis system are constructed symmetrically.

5. The thermal analysis system as recited in claim 1, characterized in that each Peltier system each thermoelectric generator is made from a material that is designed for use above 200° C., preferably above 700° C.

6. The thermal analysis system as recited in claim 1, characterized in that each Peltier system and/or each thermoelectric generator is constructed modularly from a plurality of identical components.

7. The thermal analysis system as recited in claim 1, characterized in that each Peltier system is wired electrically in such manner that it allows the thermal analysis system to be operated as a dynamic heat flux differential scanning calorimeter and/or as a power-compensated dynamic differential scanning calorimeter.

8. The thermal analysis system as recited in claim 1, characterized in that the thermal analysis system is configured as a Peltier-based hybrid dynamic differential scanning calorimeter that is operable optionally as a dynamic power-compensated of heat flux differential scanning calorimeter.

9. The thermal analysis system as recited in claim 1, characterized in that the surface of each Peltier system and/or thermoelectric generator is scratch-proof and/or corrosion-resistance.

10. The thermal analysis system as recited in claim 1, characterized in that each Peltier system and/or thermoelectric generator that is located inside the dynamic differential scanning calorimeter is/are based on a SiGe semiconductor.

11. The thermal analysis system as recited in claim 1, characterized in that tellurium, lead, bismuth or alloys and/or compounds of these elements are contained in each Peltier system and/or each thermoelectric generator of the dynamic differential scanning calorimeter.

12. The thermal analysis system as recited in claim 1, characterized in that each Peltier system and/or thermoelectric generator particularly of the dynamic differential scanning calorimeter is constructed from skutterudite systems.

13. A thermal analysis method comprising a sample crucible on a sample side and are reference crucible on a sample side in a measuring chamber, characterized in that a system based on the Peltier effect is used for capturing and/or adjusting the temperature on the sample crucible and the reference crucible.

14. The thermal analysis method as recited in claim 13, characterized in that a thermoelectric generator is used to capture the temperature on the sample crucible and the reference crucible.
